(19) United States
(12) Patent Application Publication
(10) Pub. No.: US 2025/0249989 A1
(43) Pub. Date: Aug. 7, 2025

(54) NAVIGATION ASSIST SYSTEM, NAVIGATION ASSIST METHOD, AND PROGRAM

(71) Applicant: Furuno Electric Co., Ltd., Nishinomiya-City (JP)

(72) Inventor: Seiichi UOSHITA, Nishinomiya-City (JP)

(73) Assignee: Furuno Electric Co., Ltd., Nishinomiya-City (JP)

(21) Appl. No.: 18/746,099

(22) Filed: Jun. 18, 2024

(30) Foreign Application Priority Data
Feb. 2, 2024 (JP) 2024-014524

(51) Int. Cl. B63B 43/18; B63B 49/00; G08G 3/02

(52) U.S. Cl. CPC B63B 43/18; B63B 49/00; G08G 3/02

(57) ABSTRACT

The navigation assist system is provided with: a movable body data interface configured to acquire movable body data including position and speed of a movable body moving on water; a target data interface configured to acquire target data including the position and the speed of a plurality of targets existing respectively around the movable body; an avoidance target selector configured to select one or the plurality of targets having collision risks of colliding with the movable body; and an evasion route generator configured to generate an evasion route of the movable body based on the selected targets.

### CROSS-REFERENCE TO RELATED APPLICATION

This application claims priority to Japanese Patent Application No. 2024-014524 filed on Feb. 2, 2024. The entire disclosure of Japanese Patent Application No. 2024-014524 is hereby incorporated herein by reference.

### TECHNICAL FIELD

The disclosure relates to a navigation assist system, navigation assist method, and program.

### BACKGROUND

Patent Document 1 discloses a technique in which, if an obstacle is detected in the path of a vessel while navigating following a tracking point, the vessel preferentially avoids the obstacle and then continues navigating following the tracking point.
U.S. Patent Application Publication No. 2020/0310434

By the way, if all the object targets detected by the sensor are considered in the calculation of the escape route, an unexpected escape route may be set to avoid distant object targets unnecessarily, and it may meander. As a result, the calculation of the escape route becomes complicated, and the calculation load may increase more than necessary.

### SUMMARY

The disclosure has been made in view of the above problems, and its main object is to provide a navigation assist system, a navigation assist method, and a program capable of stabilizing the calculation of the escape route.

To solve the above problem, a navigation assist system is provided according to one aspect of the disclosure that comprises: a movable body data interface configured to acquire movable body data including a position and a speed of a movable body moving on water, a target data interface configured to acquire target data including the position and the speed of a plurality of targets existing respectively around the movable body, an avoidance target selector configured to select one or the plurality of targets having collision risks of colliding with the movable body, and an evasion route generator configured to generate an evasion route of the movable body based on the selected targets.

In the above embodiment, the avoidance target selector may be configured to select one or the plurality of targets whose predicted positions are in a selection area related to the position of the movable body.

In the above embodiment, the avoidance target selector may be configured to calculate risk areas where there are collision risks between the movable body and the plurality of targets, respectively, and select targets where the risk areas are included in the selection area from the plurality of targets as the avoidance target, respectively.

In the above embodiment, the target selector may be configured to calculate a collision risk value between the movable body and each of the target based on the movable body data and the target data, and select the targets based on the collision risk.

In the above embodiment, the avoidance target selector may be configured to: calculate the collision risk value between the movable body and each of the target based on the movable body data and the target data, determine a risk area of possibility of colliding with the targets based on the collision risk value, and select the targets inside the risk area.

In the above embodiment, the evasion route generator may be configured to calculate collision risk values between the movable body and the selected targets; and generate the evasion route based on the collision risk values.

In the above embodiment, the evasion route generator may be configured to generate one or more potential evasion route patterns between the evasion start point starting at the position of the movable body and the evasion end point of the evasion route and select the evasion route from the potential evasion route patterns based on the collision risk value.

In the above embodiment, the evasion route generator may be configured to compare the risk values of the target with the largest collision risk value among the targets to be evaded in each potential evasion route and select the potential evasion route including the target with the smallest collision risk value as the evasion route.

In the above embodiment, a planned route interface may be configured to acquire a planned route of the movable body, and wherein the evasion route generator is configured to generate a plurality of potential evasion route patterns having mutually different routes departing from the planned route and returning to the planned route and select the evasion route from the potential evasion route patterns based on the collision risk value.

In the above embodiment, the evasion route generator may be configured to compare the risk values of the target with the largest collision risk value among the targets to be evaded in each potential evasion route and select the potential evasion route including the target with the smallest collision risk value as the evasion route.

In the above embodiment, the avoidance target selector may be configured to acquire predicted positions of the targets based on the target data, respectively, set a selection area relative to the position of the movable target, and select targets whose predicted positions are in the selection area; and wherein the evasion route generator is configured to generate the evasion route in a search area overlapping the selection area.

In the above embodiment, wherein the selection area may be set inside the search area.

In the above embodiment, wherein the boundary of the selection area may be set closer to the movable body than the boundary of the search area.

In the above embodiment, the avoidance target selector may be configured to determine the size of the selection area to a size where the number of targets is less than or equal to a predetermined number.

In the above embodiment, the avoidance target selector may be configured to preferentially select the targets whose risk areas are closer to the movable body.

In the above embodiment, the avoidance target selector may be configured to preferentially select the targets whose risk areas are closer to the navigation route of the movable body.

In the above embodiment, wherein: the avoidance target selector may be configured to preferentially select the targets whose risk areas are closer to the bow direction of the movable body.

In the above embodiment, the avoidance target selector may be configured to calculate an area including a section where there is a collision risk with the movable body in the predicted route of the target, assuming that the movable body travels in an arbitrary direction and crosses the predicted route of the target, as the risk area.

Further to solve the above problem, a navigation assist method is provided that comprises: acquiring movable body data including the position and speed of a movable body moving on water; acquiring target data including the position and speed of a plurality of targets existing respectively around the movable body; selecting one or a plurality of targets whose predicted positions are in a selection area related to the position of the movable body; and generate an evasion route of the movable body based on the selected targets.

Further, a computer-implemented method for planning navigation route is provided that comprises: inputting movable body data including the position and speed of a movable body moving on water; inputting target data including the position and the speed of the plurality of targets existing respectively around the movable body; selecting one or the plurality of targets whose predicted positions are in a selection area related to the position of the movable body; and generate an evasion route of the movable body based on the selected targets.

### BRIEF DESCRIPTION OF DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIG. 1 is a diagram showing an example of a navigation assist system;

FIG. 2 is a diagram showing an example of an information processor.

FIG. 3 is a diagram showing an example of a target management database.

FIG. 4 is a diagram showing an example of a display section.

FIG. 5 is a diagram showing an example of a configuration of an avoidance target selector.

FIG. 6 is a diagram showing an example of a selection area and a searching area.

FIG. 7 is a diagram showing an example of a selection area and a risk area.

FIG. 8 is a diagram showing an example of a selection database.

FIG. 9 is a diagram showing a limited example of a selection area.

FIG. 10 is a diagram showing a limited example of a selection area.

FIG. 11 is a diagram showing an example of risk area calculation.

FIG. 12 is a diagram showing an example of an evasion route generator.

FIG. 13 is a diagram showing an example of generating a pattern.

FIG. 14 is a diagram showing an example of selecting an evasion route.

FIG. 15 is a diagram showing an example of a navigation assist method.

FIG. 16 is a diagram showing a modification of the navigation assist method.

### DETAILED DESCRIPTION OF THE EMBODIMENTS

Example apparatus are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

Embodiments of the disclosure will now be described with reference to the drawings. In the present specification and the figures, elements similar to those described above with respect to the preceding figures may be denoted by the same reference numerals and detailed descriptions may be omitted as appropriate.

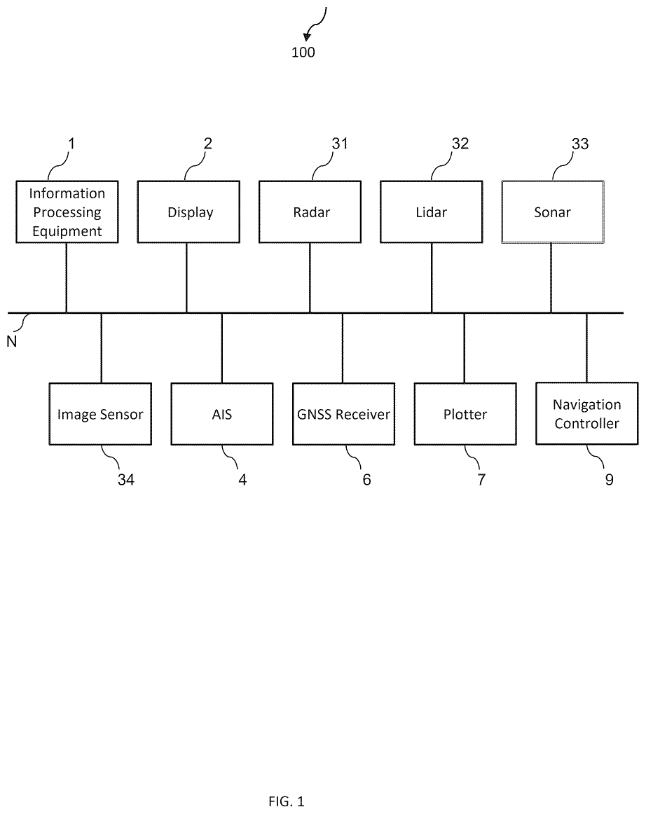

FIG. 1 is a block diagram showing a configuration example of the navigation assist system 100. The navigation assist system 100 is a system mounted on a vessel. In the following description, the vessel equipped with the navigation assist system 100 is also called an “own vessel,” and other vessels are also called “other vessels.” The own vessel is an example of a movable body moving on water.

The navigation assist system 100 includes an information processor 1, a display 2, a radar 31, a lidar 32, a sonar 33, an image sensor 34, an AIS 4, a GNSS receiver 6, a plotter 7, and a navigation controller 9. These devices are connected to a network N such as a LAN, for example, and are capable to perform network communication with each other.

The information processing equipment 1 includes a computer including a CPU, a RAM, a ROM, a nonvolatile memory, and an input/output interface. The CPU executes information processing according to a program loaded into the RAM from the ROM or the nonvolatile memory.

The program may be supplied via an information storage medium such as an optical disk or a memory card, or via a communication line such as the Internet or a LAN.

A display 2 displays a display image generated by an information processing equipment 1. The display 2 also displays a radar image, a camera image, an electronic chart, etc. The display 2 is, for example, a display device with a touch sensor, a so-called touch panel, and detects an instruction position in the screen by a user's finger or the like. Not limited to this, a pointing device such as a trackball inputs the instruction position.

The radar (electro-magnetic detection and ranging device) 31, the lidar (light detection and ranging device) 32, the sonar (acoustic navigation and ranging device) 33, and the image sensor 34 are examples of sensors that generate target data including a position and speed of a target such as another vessel. The target is not limited to a target on water such as another vessel but may also be a underwater target such as a reef.

The radar 31 emits electro-magnetic waves around the own vessel, receives the reflected waves, and generates echo data. The radar 31 identifies the target on the water from the echo data and generates target data. The target data generated by the radar 31 is also called TT data (Target Tracking Data). The lidar 32 emits laser light around the own vessel to receive the reflected light and generate an image data. The lidar 32 identifies the target on the water from the image data and generates target data. The sonar 33 emits ultrasonic waves around the own vessel and receives the reflected waves to generate echo data. The sonar 33 also identifies underwater targets from the echo data and generates target data.

The image sensor 34 captures the surroundings of the own vessel and generates image data. The image sensor 34 identifies targets included in the image data and generates target data. The function of generating target data may be realized in the information processor 1.

An AIS (Automatic Identification System) 4 receives an AIS data from another vessel or a control center on the land existing around the own vessel. The AIS data includes identification code of other vessels, vessel names, positions, courses, vessel speeds, vessel types, hull lengths, destinations, etc., and may be used as target data.

A GNSS (Global Navigation Satellite System) receiver 6 detects the position of the own vessel based on the electro-magnetic wave signals received from the GNSS (Global Navigation Satellite System).

A plotter 7 acquires the position of the own vessel from the GNSS receiver 6 and displays the position of the own vessel on the electronic chart. The plotter 7 also displays the planned route of the own vessel on the electronic chart.

A navigation controller 9 is a control device for realizing autonomous navigation and controls the steering machine of the own vessel. The navigation controller 9 may control the engine of the own vessel.

In this embodiment, the information processing equipment 1 and the display 2 are independent devices, but the information processing equipment 1 and the display 2 may be integrated devices.

Although the information processing equipment 1 is an independent apparatus in this embodiment, it is not limited thereto and may be integrated with another apparatus such as the plotter 7. That is, some or all functions of the information processing equipment 1 may be realized by another apparatus.

Although the display 2 is also an independent apparatus, but is not limited to this, the display unit of another apparatus such as the plotter 7 may be used as the display 2 for displaying the display image generated by the information processor 1.

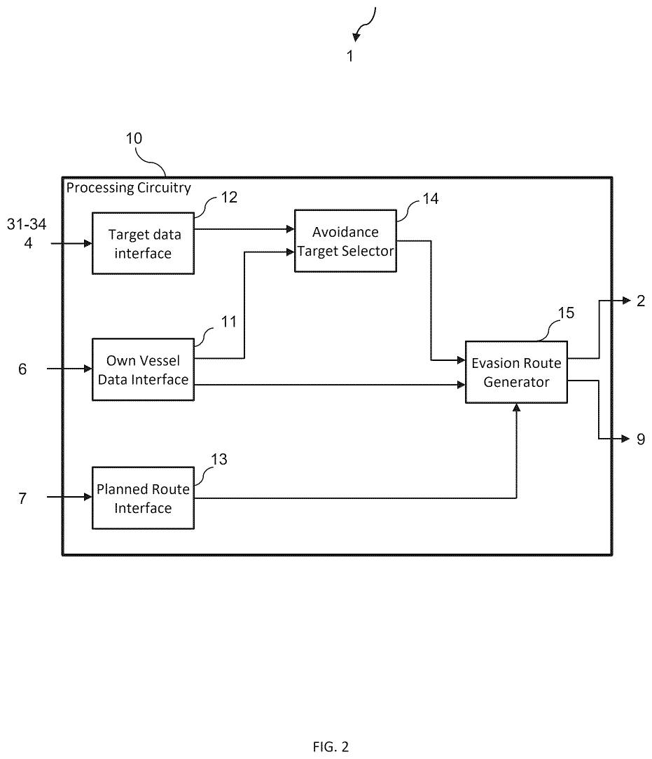

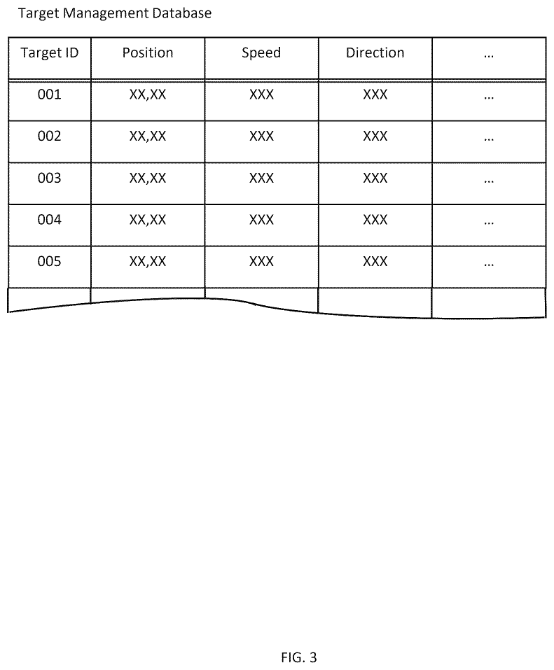

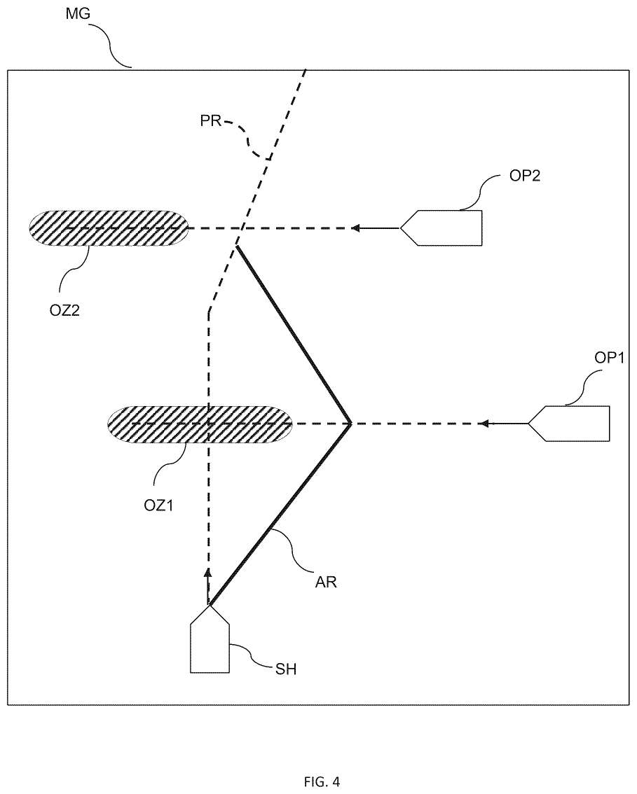

FIG. 2 is a block diagram showing a configuration example of the information processor 1. FIG. 3 is a diagram showing an example of a target management database constructed in the memory of the information processor 1. FIG. 4 is a diagram showing a display example on the display unit 2.

As shown in FIG. 2, the information processing equipment 1 includes a processing circuitry 10. The processing circuitry 10 includes an own vessel data interface 11, a target data interface 12, a planned route interface 13, an avoidance target selector 14, and an evasion route generator 15. These functional units are realized by the processing circuitry 10 executing information processing according to a program.

The own vessel data interface 11 acquires own vessel data including the position and speed of the own vessel. The own vessel data interface 11 is an example of a movable body data interface, and the own vessel data is an example of a movable body data. Velocity is a vector quantity represented by vessel speed and direction, and vessel speed is a scalar quantity. The direction is a course but may be a path (heading).

Specifically, the own vessel data interface 11 sequentially acquires the position of the own vessel detected by the GNSS receiver 6 and calculates the speed of the own vessel from the temporal change of the position of the own vessel. In addition, the vessel speed of the own vessel may be acquired from a vessel speedometer (not shown), or the direction of the own vessel may be acquired from a compass (not shown).

The target data interface 12 acquires target data, including position and speed, for each of a plurality of target present around the own vessel. The target data interface 12 sequentially acquires target data from the radar 31, the lidar 32, the sonar 33, the image sensor 34, or the AIS 4 mounted on the own vessel.

The target data interface 12 registers the acquired target data in the target management database. The target management database includes fields such as “target ID”, “position,” “vessel speed” and “direction”, as shown in FIG. 3.

The position of the target is expressed in latitude and longitude. Since the position of the target detected by a sensor such as the radar 31 is a relative position to the own vessel, it is converted to an absolute position using the position of the own vessel detected by the GNSS receiver 6.

The vessel speed and direction of the target are estimated from the temporal changes in the position of the target. In the case that the positions of a plurality of target data from different sources are the same or similar, the target data may be combined to represent a common target.

The planned route interface 13 acquires the planned route of the own vessel. The planned route is the route that the own vessel should follow between a port of departure and the destination. The planned route interface 13 may acquire the planned route from another device, such as a plotter 7, or it may create the planned route itself by accepting user input.

The own vessel navigates by automatic or manual navigation to follow the planned route. Alternatively, the own vessel may navigate manually rather than based on a planned route.

An evasion route generator 15 generates an evasion route when it becomes unavoidable to evade an obstacle during navigation of the own vessel, and outputs the generated evasion route to the display 2 and the navigation control unit 9. The display 2 displays the evasion route, and the navigation controller 9 navigates the evasion route to the own vessel.

As shown in FIG. 4, for example, the display 2 displays an image MG showing the positional relation between an own vessel SH and targets OP1 and OP2 (hereinafter collectively referred to as “target OP”). The image MG is, for example, a radar image, an electronic chart, or a composite image thereof.

The image MG displays, risk areas OZ1 and OZ2 (hereinafter collectively referred to as “risk area OZ”) that are at risk of collision between the own vessel SH and the targets OP1 and OP2. The risk area OZ is, for example, Obstacle Zone by Target (OZT).

The image MG displays, a planned route PR of the own vessel SH, and an evasion route AR. In FIG. 4, the evasion route AR which evades the risk area OZ1 of the target OP1 and returns to the planned route PR is exemplified.

By the way, in the calculation of evasion routes by the evasion route generator 15, if all targets obtained from the target data interface 12 are regarded as avoidance targets, the evasion route calculation may become unstable, and the calculation load may increase more than necessary, because the evasion route unexpectedly meanders in an attempt to avoid unnecessarily distant targets.

Therefore, in the present embodiment, the avoidance target selector 14 is provided in the preceding stage of the evasion route generator 15, for selecting targets to be avoided and targets that do not need to be avoided are excluded from avoidance targets, thereby reducing computational loads and achieving stabilization of the evasion route calculation. A specific configuration and operation of the avoidance target selector 14 and the evasion route generator 15 will be described below.

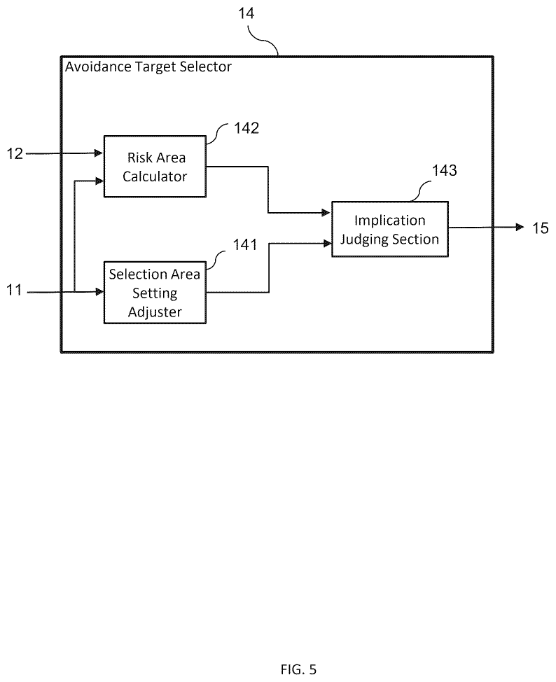

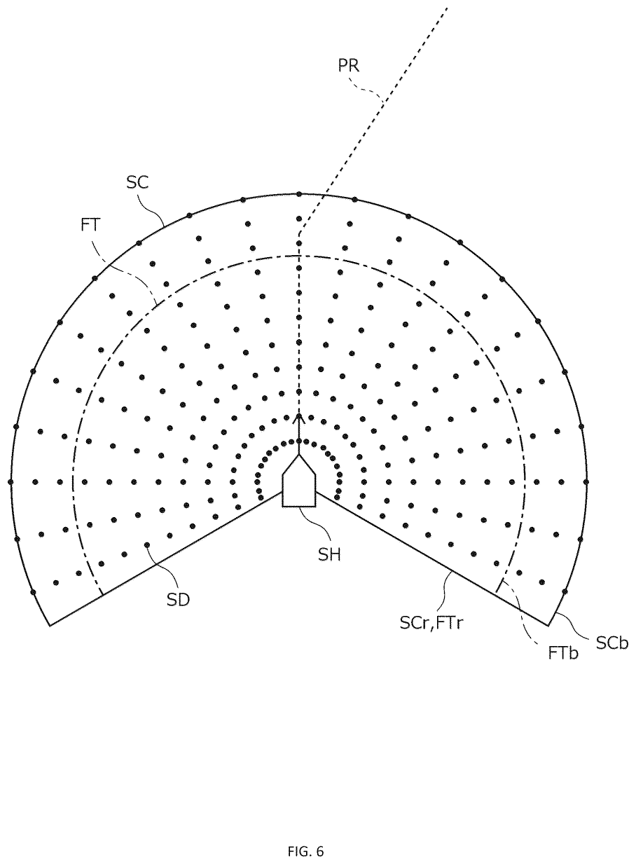

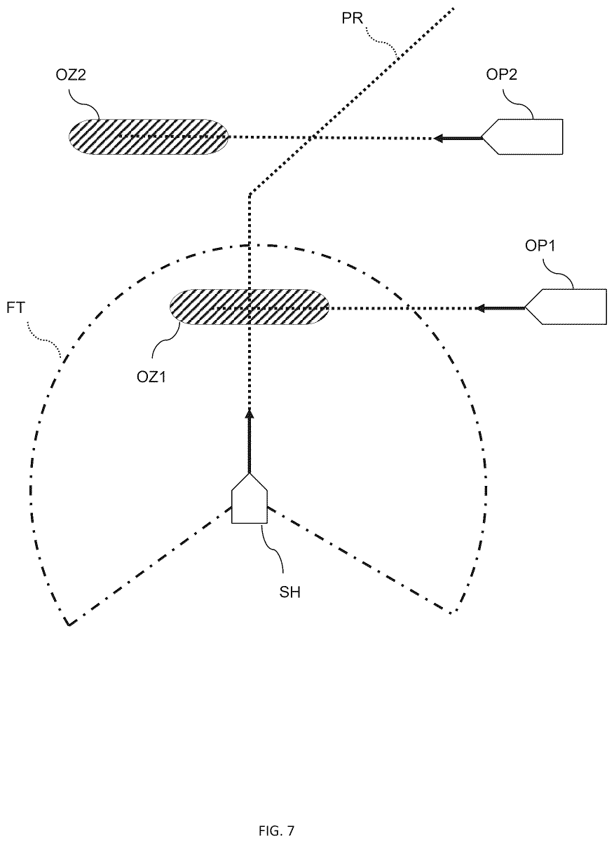

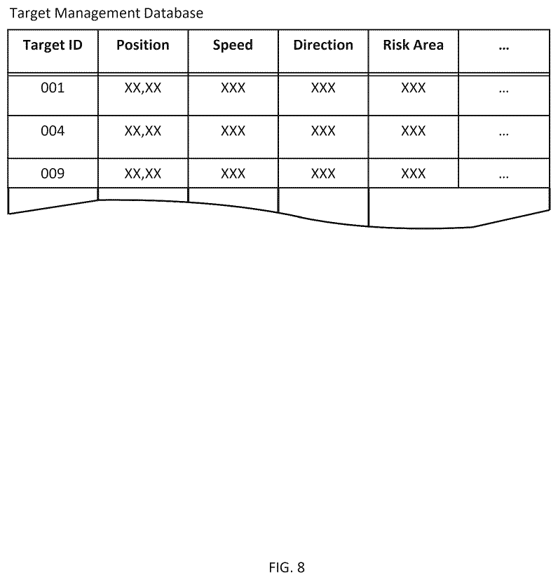

FIG. 5 is a block diagram showing a specific configuration example of the avoidance target selector 14. FIG. 6 is a diagram showing an example of a selection area FT and the searching area SC. FIG. 7 is a diagram showing an example of the selection area FT and the risk area OZ. FIG. 8 is a diagram showing an example of a selection database for managing the selected target OP.

Based on the own vessel data acquired by the own vessel data interface 11 and the target data acquired by the target data interface 12, the avoidance target selector 14 selects the target OP, whose predicted position is included in the selection area FT relative to the own vessel SH, as the avoidance target from a plurality of target OPs existing around the own vessel SH.

As shown in FIG. 5, the avoidance target selector 14 includes a selection area setting adjuster 141, a risk area calculator 142, and an implication judging section 143.

The selection area setting adjuster 141 sets the selection area FT for selecting the target OP to be the avoidance target based on the own vessel SH. As shown in FIG. 6, the selection area FT is a sector-like region centered on the path or heading of the own vessel SH, for example, where the distance from the own vessel SH or the arrival time of the own vessel SH is not more than a predetermined value.

FIG. 6 also shows the searching area SC for generating an evasion route in conjunction with the selection area FT for illustrative purposes. The searching area SC includes a number of search point SDs arranged radially around the own vessel SH. Only some of the search point SDs are shown in the figure.

The searching area SC is also set based on the own vessel SH and overlaps with the selection area FT. Similar to the selection area FT, the searching area SC is a fan-shaped area centered on the bow direction of own vessel SH, where the distance from the own vessel SH or the arrival time of the own vessel SH is less than a predetermined value. The selection area FT and the searching area SC have a similar relation.

The selection area FT is preferably set inside the searching area SC. That is, the outer peripheral edge FTb, which is the radial boundary of the selection area FT, is preferably set closer to the own vessel SH than the outer peripheral edge SCb, which is the radial boundary of the searching area SC. The reason for this will be described later.

The edge FTr, which is the circumferential boundary of the selection area FT, may coincide with the edge SCr, which is the circumferential boundary of the searching area SC, or may be anterior or posterior to the edge SCr. The shape of the selection area FT may not be limited to a fan shape, but may extend forward, or may extend to the right from the left.

The risk area calculator 142 calculates the risk area OZ that has a collision risk with the own vessel SH for each of a plurality of targets OP. The risk area OZ is, for example, an area of a predetermined width that includes a section that has a collision risk with the own vessel SH on the predicted route of target OP.

The risk area OZ may be, for example, OZT, but may also be a collision point, PAD (Predict Area of Danger) or DAC (Dangerous Area of Collision). A specific calculation method of the risk area OZ will be described later.

The implication judging section 143 selects a target OP whose selection area FT includes the risk area OZ from the plurality of targets OP, as an avoidance target. FIG. 7 shows an example in which the risk area OZ1 of the target OP1 is included in the selection area FT and the risk area OZ2 of target OP2 is not included in the selection area FT.

In this embodiment, the risk area OZ is a two-dimensional region, but it is not limited to this, and may be, for example, a line segment or a point. The risk area OZ is an example of a predicted position of the target OP. With or without the risk area OZ, the target OP that is predicted to enter the selection area FT may be selected as the avoidance target.

The implication judging section 143 registers the target data of the selected target in the screening database. The screening database may include fields such as “position”, “vessel speed,” and “direction”, as shown in FIG. 8, as well as fields such as “risk area” representing the position of the risk area OZ.

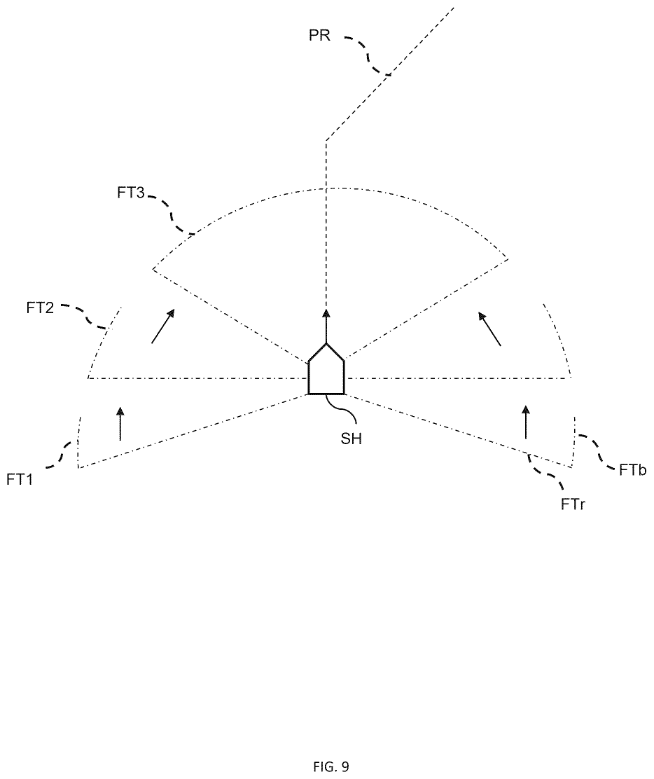

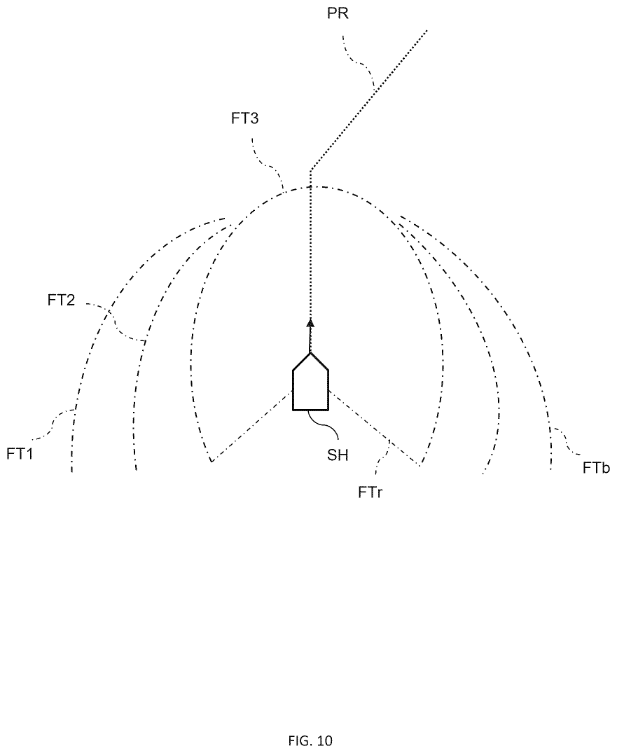

To prevent the number of the target OPs to be screened from becoming too large, the selection area FT may be a variable, as shown in FIGS. 9 and 10. That is, the selection area FT may be gradually narrowed in a way that the number of target Ops, in which the risk area OZ is included in the selection area FT, is not more than a predetermined number (FT1→FT2→FT3).

More specifically, in the case that the number of target OPs in which the risk area OZ is included in the selection area FT1 exceeds a predetermined number, the selection area setting adjuster 141 applies a selection area FT2 narrower than the selection area FT1. In the case that the number of target OPs in which the risk area OZ is included in the selection area FT2 is less than or equal to a predetermined number, the implication judging section 143 selects those target OPs as avoidance targets.

On the other hand, in the case that the number of target OPs in which the risk area OZ is included in the selection area FT2 is more than a predetermined number, the selection area setting adjuster 141 applies a selection area FT3 that is narrower than the selection area FT2. The implication judging section 143 selects the target OPs as avoidance targets when the number of target OPs including the risk area OZ in the selection area FT3 is not more than a predetermined number.

The selection area FT is narrowed to the own vessel SH or to the path or heading of the own vessel SH. For example, as shown in FIG. 9, the edge FTr, which is the boundary in the circumferential direction, may be moved closer to the path or heading of the own vessel SH, or the path or heading of the own vessel SH may be moved closer to the center as shown in FIG. 10. The width of the selection area FT may be narrowed.

In other words, narrowing the selection area FT in this way, means that the target OP is prioritized and selected as the avoidance target, whose risk area OZ is closer to the path or heading of the own vessel SH. A predetermined number of target OPs may be extracted in a order in which the risk area OZ is closer to the path or heading of the own vessel SH.

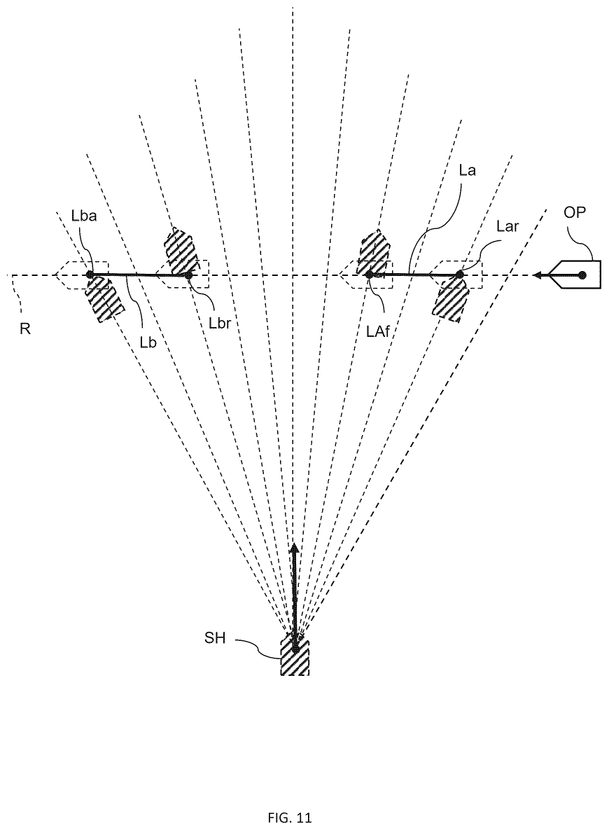

Hereinafter, an example of calculating the risk area OZ by the risk area calculator 142 will be described with reference to FIG. 11.

The risk area calculator 142 calculates the predicted position of the own vessel SH and the target OP at each time point assuming that the own vessel SH travels in an arbitrary direction and crosses the predicted route R of the target OP. In the predicted route R of the target OP the risk sections La, Lb are identified, where there is a risk of collision between the own vessel SH and the target OP, as the center sections of the risk area OZ.

The calculation of the predicted position of the own vessel SH is performed under the assumption that the own vessel SH travels in an arbitrary direction at the current position while maintaining its speed. That is, it is assumed that the magnitude of the own vessel velocity vector of the own vessel SH is constant, while the direction of the own vessel velocity vector changes in an arbitrary direction at the reference time, and the navigation continues from the own vessel position at the reference time in a constant direction thereafter. Therefore, the predicted position of the own vessel SH at each time point exists on a concentric circle centered at the own vessel position at the reference time point. The radius of the circle is expressed as the product of the elapsed time from the reference time point and the magnitude of the own vessel velocity vector.

The predicted position of the own vessel SH at each time point is expressed as a plurality of concentric circles calculated for each discrete plurality of time points. Without limitation, the predicted position of the own vessel SH at each time point may be expressed as a circle expression including the elapsed time from the reference time point.

In the present embodiment, the predicted position of the own vessel SH is calculated under the assumption that the speed of the own vessel SH is constant, but is not limited to this and the speed of the own vessel SH may be treated as a variable that changes with time. That is, the speed of the own vessel SH may not be constant if the predicted position of the own vessel SH is determined according to the elapsed time from the reference time point. For example, the speed of the own vessel SH may gradually increase or decrease over time.

The predicted position of the target OP is calculated under the assumption that the target OP is traveling at a sustained speed from its current position. That is, the target OP is assumed to be traveling at a sustained speed from its target position at the reference time, with the magnitude and direction of the target speed vector constant. Therefore, the predicted position of the target OP at each time point lies on a straight line extending the target speed vector through the target position at the reference time point.

The predicted position of the target OP at each time point is represented by a discrete plurality of points aligned on the straight line, calculated for each of the discrete plurality of time points. Without limitation, the predicted position of the target OP at each time point may be represented by a linear function passing through the target position of the reference time point.

In the present embodiment, the predicted position of the target OP is calculated on the assumption that the speed of the target OP is constant, but it is not limited to this, and may be treated as a variable in which at least one of the speed and direction of the target OP changes with time. That is, if the predicted position of the target OP is determined according to the elapsed time from the reference time point, the speed of the target OP may not be constant. For example, the speed of the target OP may gradually increase or decrease over time. The target OP may change path in a predetermined direction or turn at a predetermined ROT (Rate of Turn).

The risk area calculator 142 calculates the distance between the predicted position of the own vessel SH and the predicted position of the target OP at each time point, and calculates the risk of collision or approach based on the distance and the vessel size. As described above, the predicted position of the own vessel SH at a certain time point is represented by a circle, so the risk area calculator 142 calculates the distance by extracting the position closest to the predicted position of the target OP at the same time point from the circle representing the predicted position of the own vessel SH at a certain time point.

The risk area calculator 142 identifies the risk sections La and Lb for having a collision risk when, for example, the area of the own vessel SH overlaps with the point representing the predicted position of the target OP. In addition, there may be a collision risk when the warning area set around the own vessel SH overlaps with a point representing the predicted position of the target OP. Hereinafter, the traveling direction of the target OP is also referred to as forward, and the opposite direction is referred to as backward.

For example, with regard to the first risk section La, which is positioned on the backward side of the two risk sections La and Lb, the rear end Lar of the first risk section La is positioned in a way that the front end of the own vessel SH abuts the point representing the predicted position of the target OP. The front end Laf of the first risk section La is positioned in a way that the rear end of the own vessel SH abuts the point representing the predicted position of the target OP.

On the other hand, for the second risk section Lb, which is positioned on the forward side of the two risk sections La and Lb, the rear end Lbr of the second risk section Lb is positioned in a way that the rear end of the own vessel SH abuts the point representing the predicted position of the target OP. The front end Lbf of the second risk section Lb is positioned in a way that the front end of the own vessel SH abuts the point representing the predicted position of the target OP.

The range between the first risk section La and the second risk section Lb is a range over which the own vessel SH crosses the front of the target OP. On the other hand, the range behind the first risk section La and the range ahead of the second risk section Lb is a range where the own vessel SH crosses behind the target OP.

The risk area calculator 142 may have a collision risk when a warning area set in or around the area of the own vessel SH overlaps with a warning area set in or around the area of the target OP. The risk area calculator 142 may use the collision point where the point representing the predicted position of the own vessel SH overlaps with the point representing the predicted position of the target OP as a risk area.

In this embodiment, the collision risk is calculated based on a distance such as a distance between the predicted position of the own vessel SH and the predicted position of the target OP. However, the collision risk may be calculated based on a time such as, for example, an approach time, until the own-vessel SH and the target OP come closest to each other, or an arrival time, until the own-vessel SH reaches the predicted position of the target OP.

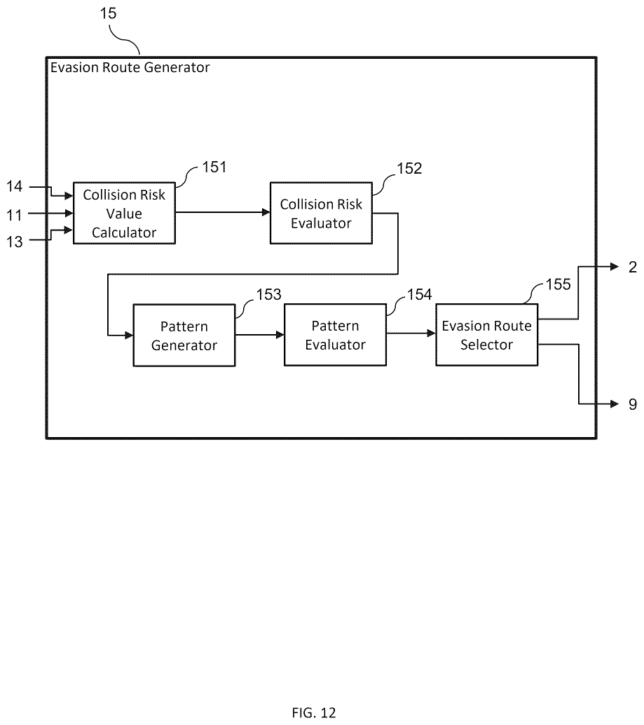

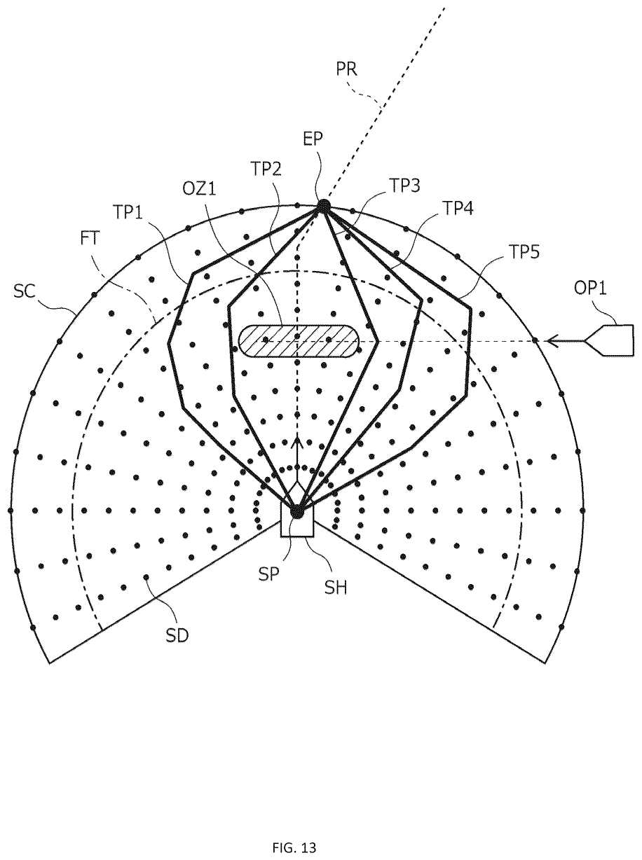

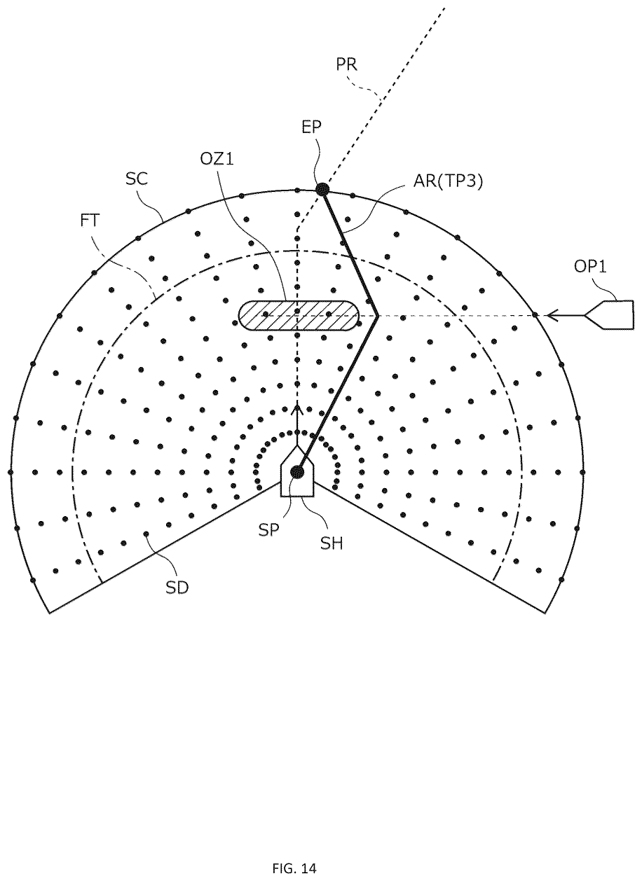

FIG. 12 is a block diagram showing a specific configuration example of the evasion route generator 15. FIG. 13 shows an example of generating potential evasion route patterns TP1 to TP5. FIG. 14 shows an example of selecting an evasion route AR.

The evasion route generator 15 generates the evasion route AR using the target OP as the avoidance target selected by the avoidance target selector 14. That is, the evasion route generator 15 calculates a collision risk value between the own vessel SH and the selected target OP, and generates the evasion route AR based on the calculated collision risk value.

As shown in FIG. 12, the evasion route generator 15 includes a collision risk value calculator 151, a collision risk evaluator 152, a pattern generator 153, a pattern evaluator 154, and an evasion route selector 155.

The collision risk value calculator 151 calculates the collision risk value between the own vessel SH and the selected target OP when the own vessel SH navigates the planned route PR based on the own vessel data acquired by the own vessel data interface 11, the target data of the target OP selected by the avoidance target selector 14, and the planned route PR of the own vessel SH acquired by the planned route interface 13.

In the case that the navigation is not based on planned route PR, the collision risk value calculator 151 treats the extension of the path of the own vessel SH as a planned route.

FIGS. 13 and 14 show an example in which the planned route PR of the own vessel SH interferes with predicted route of selected target OP1. That is, when the own vessel SH navigates the planned route PR, it passes the risk area OZ1 of the target OP1. In such a case, the collision risk value becomes high.

Specifically, the collision risk value calculator 151 calculates the collision risk value using the Time to Closest Point of Approach (TCPA) and Distance to Closest Point of Approach (DCPA) of the CPA collision warning, but is not limited to this and Bow Crossing Time (BCT) and Bow Crossing Range (BCR) may also be used.

The collision risk value calculator 151 may calculate the collision risk value by using the time until the target OP enters the bumper area set with respect to the own vessel SH and the distance to the own vessel SH when the target OP enters the bumper area. Conversely, a bumper area may be set in the target OP.

The collision risk evaluator 152 determines whether the own vessel SH should deviate from the planned route PR and avoid the selected target OP based on the collision risk value calculated by the collision risk value calculator 151. The collision risk evaluator 152 determines that “evacuation is unavoidable” when the collision risk value becomes equal to or greater than the threshold value.

The pattern generator 153, the pattern evaluator 154, and the evasion route selector 155 calculate the evasion route AR for avoiding the selected target OP when the collision risk evaluator 152 determines that evacuation is unavoidable.

The pattern generator 153 generates a plurality of potential evasion route patterns TP1 to TP5 (hereinafter collectively referred to as “potential evasion route pattern TP”) in the searching area SC, as shown in FIG. 13. The potential evasion route pattern TP is a candidate pattern for the evasion route AR.

The potential evasion route pattern TP is generated between the evasion start point SP and the evasion end point EP. The evasion start point SP starts from the position of the own vessel SH. The evasion end point EP is the intersection of the planned route PR and the boundary of the searching area SC.

The potential evasion route pattern TP is constructed by sequentially connecting search points SD arranged radially within the searching area SC from the position of the own vessel SH to the boundary of the searching area SC outward.

As described above, in this embodiment, the selection area FT is set inside the searching area SC. Thus, as shown in FIG. 13, the potential evasion route pattern TP may be formed to avoid the target OP in the selection area FT, while it is formed in the region outside the selection area FT and inside the searching ridge SC, toward the evasion end point EP.

That is, the region outside the selection area FT and inside the searching ridge SC (more specifically, the perimeter region outside the boundary of the selection area FT and inside the boundary of the searching area SC.) may be used as the region for making the end portion of the potential evasion route pattern TP go toward the evasion end point EP.

The pattern evaluator 154 calculates a collision risk value for each of the potential evasion route patterns TP for the selected target OP. The collision risk value of the potential evasion route pattern TP is a value obtained by calculating the collision risk values of the own vessel SH and the target OP at each position in the pattern and integrating them.

The pattern evaluator 154 calculates the path length for each of the potential evasion route patterns TP.

The evasion route selector 155 selects the evasion route AR from the potential evasion route patterns TP. Specifically, among the potential evasion route patterns TP, the evasion route selector 155 selects the potential evasion route pattern TP with the lowest cost, based on the collision risk value and the route length, as the evasion route AR.

FIG. 14 shows an example in which among the potential evasion route patterns TP1 to TP5, the potential route pattern TP3 with the shortest route length passing behind the target OP1 is selected as the evasion route AR.

When there are a plurality of selected target OPs, the evasion route selector 155 preferably selects the potential evasion route pattern TP for which the collision risk value of the target OP is the maximum among the selected target OPs and the collision risk value of the target OP is the minimum as the evasion route AR.

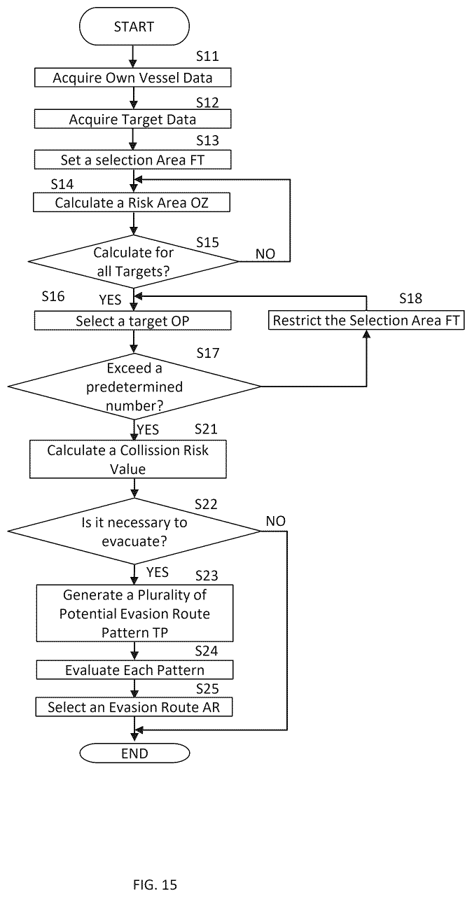

FIG. 15 is a flowchart showing an example of the navigation support method implemented in the navigation assist system 100. The processing circuitry 10 of the information processing equipment 1 executes the information processing shown in the figure according to a program.

First, the processing circuitry 10 acquires own vessel data (S11, processing as own vessel data interface 11).

Next, the processing circuitry 10 acquires target data for each of a plurality of target OP existing around the own vessel SH (S12, processing as target data interface 12).

Next, the processing circuitry 10 sets the selection area FT relative to the own vessel SH (S13, processing as the selection area setting adjuster 141, see FIG. 6).

Next, the processing circuitry 10 calculates the risk area OZ between the own vessel SH and the plurality of the target OPs (Processing as S14, S15, the risk area calculator 142, see FIG. 7).

Next, the processing circuitry 10 selects a target OP whose risk area OZ is included in the selection area FT from the plurality of the target OP as an avoidance target (Processing as section 16, implication judging section 143).

In the case that the number of target OPs whose risk area OZ is included in the selection area FT exceeds a predetermined number (S17: NO), the processing circuitry 10 restricts the selection area FT (See S18, FIG. 9 or FIG. 10) and selects the target OP, whose risk area OZ is included in the limited selection area FT, as an avoidance target (S16).

Next, the processing circuitry 10 calculates a collision risk value between the own vessel SH and the selected target OP (Processing as S21, the collision risk value calculator 151).

Next, the processing circuitry 10 determines whether or not the evacuation is necessary based on the calculated collision risk value (S22, processing as the collision risk evaluator 152).

When it is determined that the evacuation is unavoidable (S22: YES), the processing circuitry 10 generates a plurality of potential evasion route pattern TP (S23, processing as the pattern generator 153, see FIG. 13).

Next, the processing circuitry 10 calculates a collision risk value and a route length for each potential evasion route pattern TP and evaluates each potential route pattern TP (Processing as S24, the pattern evaluator 154).

Thereafter, the processing circuitry 10 selects the evasion route AR based on the evaluation of each potential route pattern TP (S25, processing as the evasion route selector 155, see FIG. 14). The selected evasion route AR is output to the display 2 and the navigation control unit 9, and the series of processing is completed.

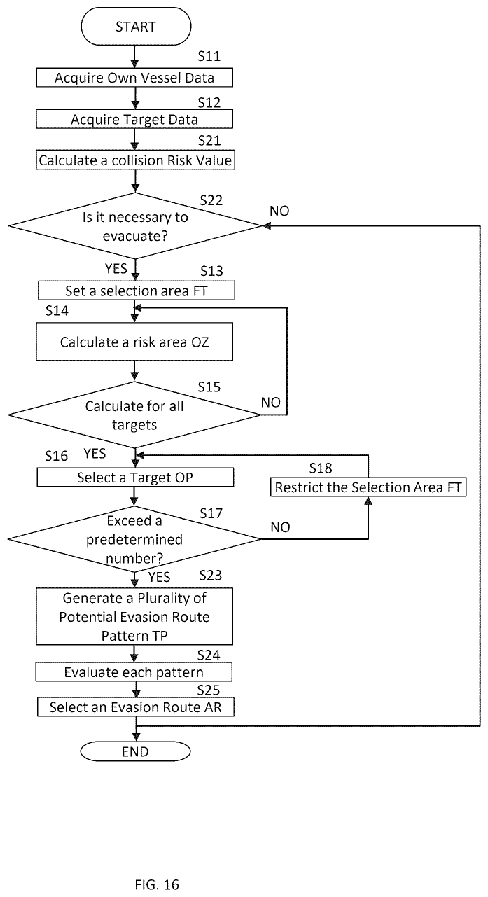

In addition to this order, as shown in the example of FIG. 16, the collision risk value between the own vessel SH and the target OP may be calculated (S21), and the process for selecting the target OP may be executed (S13 to S17) after it has been determined whether the evacuation is unavoidable (S22: YES).

Although the embodiments of the disclosure have been described above, the disclosure is not limited to the embodiments described above, and it is of course possible for a person skilled in the art to make various changes.

### REFERENCE SIGNS LIST

1 information processing equipment
2 display
31 radar
32 lidar
33 sonar
34 image sensor
4 AIS (Automatic Identification System)
6 GNSS (Global Navigation Satellite System) receiver
7 plotter
9 navigation controller
10 processing circuitry
11 own vessel data interface
12 target data interface
13 planned route interface
14 avoidance target selector
15 evasion route generator
100 navigation assist system
141 selection area setting adjuster
142 risk area calculator
143 implication judging section
151 collision risk value calculator
152 collision risk evaluator
153 pattern generator
154 pattern evaluator
155 evasion route selector

It is to be understood that not necessarily all objectives or advantages may be achieved in accordance with any particular embodiment described herein. Thus, for example, those skilled in the art will appreciate that certain embodiments may be configured to operate in a manner that achieves or optimizes one advantage or group of advantages as taught herein without necessarily achieving other objects or advantages as may be taught or suggested herein.

All processes described herein may be embodied in, and fully automated via, software code modules executed by a computing system that includes one or more computers or processors. The software code modules may be stored in any type of non-transitory computer-readable medium or other computer storage device. Some or all methods may be embodied in specialized computer hardware.

Many other variations other than those described herein will be apparent from this disclosure. For example, depending on the embodiment, certain actions, events, or functions of any of the algorithms described herein may be performed in different sequences, and may be added, merged, or excluded altogether (e.g., not all described actions or events are required to execute the algorithm). Moreover, in certain embodiments, operations or events are performed in parallel, for example, through multithreading, interrupt handling, or through multiple processors or processor cores, or on other parallel architectures, rather than sequentially. In addition, different tasks or processes may be performed by different machines and/or computing systems that may work together.

The various exemplary logical blocks and modules described in connection with the embodiments disclosed herein may be implemented or executed by a machine such as a processor. The processor may be a microprocessor, but alternatively, the processor may be a controller, a microcontroller, or a state machine, or a combination thereof. The processor may include an electrical circuit configured to process computer executable instructions. In another embodiment, the processor includes an application specific integrated circuit (ASIC), a field programmable gate array (FPGA), or other programmable device that performs logical operations without processing computer executable instructions. The processor may also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, the processor may also include primarily analog components. For example, some or all of the signal processing algorithms described herein may be implemented by analog circuitry or mixed analog and digital circuitry. A computing environment may include any type of computer system, including, but not limited to, a computer system that is based on a microprocessor, mainframe computer, a digital signal processor, a portable computing device, a device controller, or a computing engine within the device.

Unless otherwise stated, conditional languages such as “can,” “could,” “will,” “might,” or “may” are understood within the context as used in general to convey that certain embodiments include, while other embodiments do not include, certain features, elements and/or steps. Thus, such conditional languages are not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive languages, such as the phrase “at least one of X, Y, or Z,” unless specifically stated otherwise, is understood with the context as used in general to present that an item, term, etc., may be either X, Y, or Z, or any combination thereof (e.g., X, Y, and/or Z). Thus, such a disjunctive language is not generally intended to, and should not, imply that certain embodiments require at least one of X, at least one of Y, or at least one of Z to each be present.

Any process descriptions, elements, or blocks in the flow diagrams described herein and/or shown in the accompanying drawings should be understood as potentially representing modules, segments, or parts of code, including one or more executable instructions for implementing a particular logical function or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices may also be collectively configured to carry out the stated recitations. For example, “a processor configured to carry out recitations A, B and C” may include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” may be interchanged with the term “ground” or “water surface”. The term “vertical” refers to a direction perpendicular to the horizontal as just defined. Terms such as “above,” “below,” “bottom,” “top,” “side,” “higher,” “lower,” “upper,” “over,” and “under” are defined with respect to the horizontal plane.

As used herein, the terms “attached,” “connected,” “coupled,” and other such relational terms should be construed, unless otherwise noted, to include removable, moveable, fixed, adjustable, and/or releasable connections or attachments. The connections/attachments may include direct connections and/or connections having intermediate structure between the two components discussed.

Numbers preceded by a term such as “approximately,” “about,” and “substantially” as used herein include the recited numbers, and also represent an amount close to the stated amount that still performs a desired function or achieves a desired result. For example, the terms “approximately,” “about,” and “substantially” may refer to an amount that is within less than 10% of the stated amount. Features of embodiments disclosed herein preceded by a term such as “approximately,” “about,” and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

1. A navigation assist system for assisting setting navigation route, comprising:
processing circuitry configured to:
acquire, by a movable body data interface, movable body data including a position and a speed of a movable body moving on water;
acquire, by a target data interface, target data including the position and the speed of a plurality of targets existing respectively around the movable body;
select, by an avoidance target selector, one or the plurality of targets having collision risks of colliding with the movable body; and
generate, by an evasion route generator, an evasion route of the movable body based on the selected targets.

2. The navigation assist system of claim 1, wherein the processing circuitry is further configured to:
select, by the avoidance target selector, one or the plurality of targets whose predicted positions are in a selection area related to the position of the movable body.

3. The navigation assist system of claim 2, wherein the processing circuitry is further configured to:
calculate, by the avoidance target selector, risk areas where there are collision risks between the movable body and the plurality of targets, respectively, and
select targets, where the risk areas are included in the selection area from the plurality of targets, as an avoidance target, respectively.

4. The navigation assist system of claim 1, wherein the processing circuitry is further configured to:
calculate, by the avoidance target selector, a collision risk value between the movable body and each of the target based on the movable body data and the target data; and
select the targets based on the collision risk.

5. The navigation assist system of claim 1, wherein the processing circuitry is further configured to:
calculate, by the avoidance target selector, a collision risk value between the movable body and each of the target based on the movable body data and the target data;
determine a risk area of possibility of colliding with the targets based on the collision risk value; and
select the targets inside the risk area.

6. The navigation assist system of claim 1, wherein the processing circuitry is further configured to:
calculate, by the evasion route generator, collision risk values between the movable body and the selected targets; and
generate the evasion route based on the collision risk values.

7. The navigation assist system of claim 6, wherein the processing circuitry is further configured to:
generate, by the evasion route generator, one or more potential evasion route patterns between the evasion start point starting at the position of the movable body and the evasion end point of the evasion route, and
select the evasion route from the potential evasion route patterns based on the collision risk value.

8. The navigation assist system of claim 7, wherein the processing circuitry is further configured to:
compare, by the evasion route generator, the risk values of the target with the largest collision risk value among the targets to be evaded in each potential evasion route, and
select the potential evasion route including the target with the smallest collision risk value as the evasion route.

9. The navigation assist system of claim 6, further comprising:
a planned route interface configured to acquire a planned route of the movable body, and
wherein the evasion route generator is configured to;
generate a plurality of potential evasion route patterns having mutually different routes departing from the planned route and returning to the planned route, and
select the evasion route from the potential evasion route patterns based on the collision risk value.

10. The navigation assist system of claim 9, wherein the processing circuitry is further configured to:
compare, by the evasion route generator, the risk values of the target with the largest collision risk value among the targets to be evaded in each potential evasion route, and
select the potential evasion route including the target with the smallest collision risk value as the evasion route.

11. The navigation assist system of claim 1, wherein the processing circuitry is further configured to:
acquire, by the avoidance target selector, predicted positions of the targets based on the target data, respectively,
set the selection area relative to the position of the movable target, and
select the targets whose predicted positions are in the selection area; and
wherein the evasion route generator is configured to generate the evasion route in a search area overlapping the selection area.

12. The navigation assist system of claim 11, wherein
the selection area is set inside the search area.

13. The navigation assist system of claim 11, wherein
the boundary of the selection area is set closer to the movable body than the boundary of the search area.

14. The navigation assist system of claim 1, wherein the processing circuitry is further configured to:
determine, by the avoidance target selector, the size of the selection area to a size where the number of targets is less than or equal to a predetermined number.

15. The navigation assist system of claim 1, wherein the processing circuitry is further configured to:
select, by the avoidance target selector, preferentially the targets whose risk areas are closer to the movable body.

16. The navigation assist system of claim 1, wherein the processing circuitry is further configured to:
select, by the avoidance target selector, preferentially the targets whose risk areas are closer to the navigation route of the movable body.

17. The navigation assist system of claim 1, wherein the processing circuitry is further configured to:
select, by the avoidance target selector, preferentially the targets whose risk areas are closer to the bow direction of the movable body.

18. The navigation assist system of claim 1, wherein the processing circuitry is further configured to:
calculate, by the avoidance target selector, an area including a section where there is a collision risk with the movable body in the predicted route of the target, assuming that the movable body travels in an arbitrary direction and crosses the predicted route of the target, as the risk area.

19. A navigation assist method for assisting setting navigation route, comprising:
acquiring movable body data including position and speed of a movable body moving on water;
acquiring target data including the position and the speed of a plurality of targets existing respectively around the movable body;
selecting one or the plurality of targets whose predicted positions are in a selection area related to the position of the movable body; and
generate an evasion route of the movable body based on the selected targets.

20. A computer-implemented program for assisting setting navigation route, comprising:
inputting movable body data including position and speed of a movable body moving on water;
inputting target data including the position and the speed of a plurality of targets existing respectively around the movable body;
selecting one or the plurality of targets whose predicted positions are in a selection area related to the position of the movable body; and
generate an evasion route of the movable body based on the selected targets.
